(19) United States
(12) Patent Application Publication
(10) Pub. No.: US 2025/0355869 A1
(43) Pub. Date: Nov. 20, 2025

(54) OPTIMIZATION OF DATABASE QUERIES HAVING MULTIPLE VIEWS

(71) Applicant: SAP SE, Walldorf (DE)

(72) Inventors: Xun Zhang, Xi'an (CN); Yinghua Ouyang, Xi'an (CN); Zhen Tian, Xi'an (CN)

(21) Appl. No.: 18/666,093

(22) Filed: May 16, 2024

(51) Int. Cl. G06F 16/2453

(52) U.S. Cl. CPC G06F 16/24535

(57) ABSTRACT

Arrangements for optimization of database queries having multiple views are provided. A query defining multiple views may be received. A parse tree may be generated based on the query. The query may be preprocessed using the parse tree. The parse tree may be traversed to identify the multiple views. View unfolding may be executed to generate a view subtree. The view subtree may be attached to the parse tree and a view query compile tree may be generated. It may be determined whether there is another view defined by the query. In response to determining that there is not another view, the parse tree may be traversed to calculate tree depth. In response to determining that there is another view defined by the query, calculation of the tree depth may be skipped.

### TECHNICAL FIELD

The subject matter described herein relates generally to data processing and more specifically to optimization of database queries having multiple views.

### BACKGROUND

Data about an application object may be distributed across several tables. By defining a structured query language (SQL) view, a user may define an application-dependent view that combines this data. The structure of such a view is defined by specifying the tables and fields used in the view. A view may be used for data selection. Oftentimes, multiple structured query language views on data may be created by a query. When executing a query having multiple SQL views, maximum depth check on a global parse tree is performed multiple times. Such a process is inefficient, time-consuming, and reduces query execution performance.

### SUMMARY

Methods, systems, and articles of manufacture, including computer program products, are provided for optimization of database queries having multiple views. In one aspect, there is provided a system including at least one processor and at least one memory. The at least one memory can store instructions that cause operations when executed by the at least one processor. The operations may include: receiving a query, wherein the query defines multiple views; generating a parse tree based on the query; preprocessing the query using the parse tree; traversing the parse tree to identify the multiple views; executing, for a current view of the multiple views, view unfolding to generate a view subtree; attaching the view subtree to the parse tree; generating a view query compile tree; and determining whether there is another view defined by the query. In response to determining that there is not another view defined by the query, the operations may further include: traversing the parse tree to calculate tree depth of the parse tree; determining whether the tree depth exceeds a predetermined value; and in response to determining that the tree depth does not exceed the predetermined value, generating an execution plan. In response to determining that there is another view defined by the query, the operations may further include skipping calculation of the tree depth of the parse tree.

In some variations, one or more of the features disclosed herein including the following features can optionally be included in any feasible combination. In some variations, the operations may further include, in response to determining that there is another view defined by the query: executing subsequent view unfolding to generate a subsequent view subtree; and attaching the subsequent view subtree to the parse tree.

In some variations, the preprocessing may include semantic and syntactic checking of the query using the parse tree.

In some variations, determining whether there is another view defined by the query may include determining whether the current view is a last view defined by the query.

In some variations, the operations may further include: in response to determining that there is another view defined by the query, performing view unfolding for a next view and attaching a view subtree for the next view to the parse tree.

In some variations, the predetermined value may include a maximum tree depth.

In some variations, the operations may further include: in response to determining that the tree depth exceeds a predetermined value, outputting an error message.

In some variations, the operations may further include: in response to determining that the tree depth does not exceed the predetermined value, generating a query optimized tree.

In some variations, the operations may further include: transmitting the execution plan to an execution engine.

In another aspect, there is provided a method for optimization of database queries having multiple views. The method may include: receiving a query, wherein the query defines multiple views; generating a parse tree based on the query; preprocessing the query using the parse tree; traversing the parse tree to identify the multiple views; executing, for a current view of the multiple views, view unfolding to generate a view subtree; attaching the view subtree to the parse tree; generating a view query compile tree; and determining whether there is another view defined by the query. In response to determining that there is not another view defined by the query, the method may further include: traversing the parse tree to calculate tree depth of the parse tree; determining whether the tree depth exceeds a predetermined value; and in response to determining that the tree depth does not exceed the predetermined value, generating an execution plan. In addition, in response to determining that there is another view defined by the query, the method may further include skipping calculation of the tree depth of the parse tree.

In some variations, one or more of the features disclosed herein including the following features can optionally be included in any feasible combination. In some variations, the operations may further include, in response to determining that there is another view defined by the query: executing subsequent view unfolding to generate a subsequent view subtree; and attaching the subsequent view subtree to the parse tree.

In some variations, the preprocessing may include semantic and syntactic checking of the query using the parse tree.

In some variations, determining whether there is another view defined by the query may include determining whether the current view is a last view defined by the query.

In some variations, the operations may further include: in response to determining that there is another view defined by the query, performing view unfolding for a next view and attaching a view subtree for the next view to the parse tree.

In some variations, the predetermined value may include a maximum tree depth.

In some variations, the operations may further include: in response to determining that the tree depth exceeds a predetermined value, outputting an error message.

In some variations, the operations may further include: in response to determining that the tree depth does not exceed the predetermined value, generating a query optimized tree.

In some variations, the operations may further include: transmitting the execution plan to an execution engine.

In another aspect, there is provided a computer program product that includes a non-transitory computer readable medium. The non-transitory computer readable medium may store instructions that cause operations when executed by at least one processor. The operations may include: receiving a query, wherein the query defines multiple views; generating a parse tree based on the query; preprocessing the query using the parse tree; traversing the parse tree to identify the multiple views; executing, for a current view of the multiple views, view unfolding to generate a view subtree; attaching the view subtree to the parse tree; generating a view query compile tree; and determining whether there is another view defined by the query. In response to determining that there is not another view defined by the query, the operations may further include: traversing the parse tree to calculate tree depth of the parse tree; determining whether the tree depth exceeds a predetermined value; and in response to determining that the tree depth does not exceed the predetermined value, generating an execution plan. In addition, in response to determining that there is another view defined by the query, the operations may further include skipping calculation of the tree depth of the parse tree.

In some variations, one or more of the features disclosed herein including the following features can optionally be included in any feasible combination. In some variations, in response to determining that there is another view defined by the query: executing subsequent view unfolding to generate a subsequent view subtree; and attaching the subsequent view subtree to the parse tree.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an illustrative computing environment for optimization of database queries having multiple views in accordance with some example embodiments;

FIG. 2 depicts a flowchart illustrating a process for optimizing database queries having multiple views in accordance with some example embodiments;

FIG. 3 depicts an example query parse tree in accordance with some example embodiments;

FIG. 4 depicts an example query compile tree in accordance with some example embodiments; and

FIG. 5 depicts a block diagram illustrating a computing system, in accordance with some example embodiments.

When practical, similar reference numbers denote similar structures, features, or elements.

### DETAILED DESCRIPTION

Aspects of the disclosure provide a technical solution that addresses problems associated with the optimization of database queries having multiple views. For example, aspects of the disclosure provide a multiple view query optimization computing platform for increased performance, process automation, and data stability. Further aspects of the disclosure introduce a method to efficiently unfold SQL views in query processing. Further aspects of the disclosure may reduce redundant maximum depth check. Advantageously, processing of the queries that contain many views may be accelerated. These and various other arrangements will be discussed more fully below.

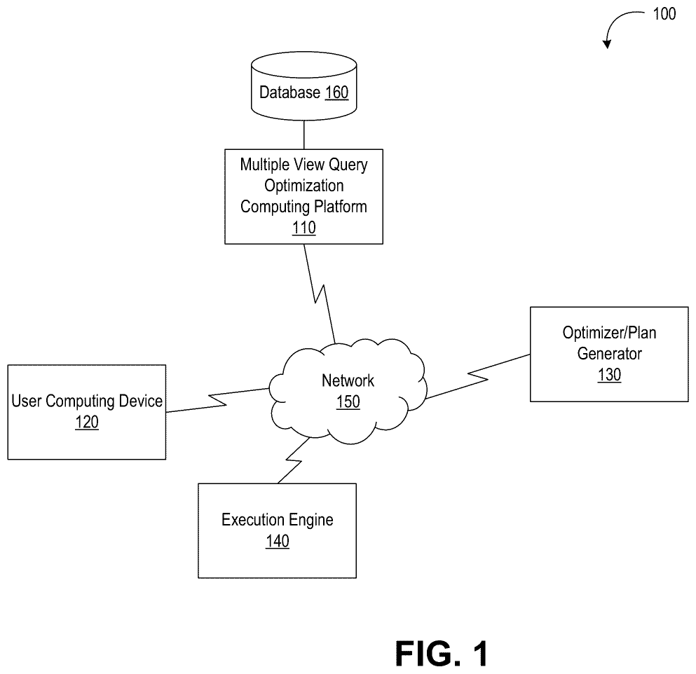

FIG. 1 depicts an illustrative computing environment 100 for optimization of database queries having multiple views in accordance with some example embodiments. Referring to FIG. 1, the computing environment 100 may include one or more computing devices and/or other computing systems. For example, computing environment 100 may include an multiple view query optimization computing platform 110, a user computing device 120, a optimizer/plan generator 130, an execution engine 140, and a database 160. Multiple view query optimization computing platform 110 may include one or more computing devices configured to perform one or more of the functions described herein. Among other features, multiple view query optimization computing platform 110 may, while traversing a global parse tree (e.g., an abstract syntax tree) to unfold SQL views in query compile (QC) plan generation, check whether the view is the last one. If the view is not the last view, then multiple view query optimization computing platform 110 may attach the view subtree to the global parse tree after view unfolding, and skip maximum tree depth check on the global parse tree. Otherwise, if the view is the last view, indicating that all views have been unfolded, multiple view query optimization computing platform 110 then performs a maximum tree depth check on the global parse tree. Thus, maximum tree depth is performed once, regardless of how many views are present.

User computing device 120 may be a processor-based device including, for example, a smartphone, a tablet computer, a wearable apparatus, a virtual assistant, an Internet-of-Things (IoT) appliance, and/or the like. Database 160 may include, for example, a relational database, an in-memory database, a graph database, a key-value store, a document store, and/or the like. In some examples, the multiple view query optimization computing platform 110 may maintain (e.g., store) various types of data, including static and nonstatic data (e.g., system data, customizing data, master data, application data, log data, and/or the like) in one or more database tables at a database 160 coupled with the multiple view query optimization computing platform 110.

Optimizer/plan generator 130 may be implemented by a server. Optimizer/plan generator 130 may produce a query execution plan for executing a query request in a “cost effective” manner. For example, optimizer/plan generator 130 parses an optimizes a request, and also generates a query plan for executing the request, as discussed further below. Optimizer/plan generator 130 may determine the most optimal execution plan for an SQL statement to access requested data. Once generated, optimizer/plan generator 130 passes the query plan to execution engine 140. Execution engine 140 processes the query plan.

Referring again to FIG. 1, the multiple view query optimization computing platform 110, the user computing device 120, the optimizer/plan generator 130, the execution engine 140, and the database 160 may be communicatively coupled via a network 150. The network 150 may be a wired and/or wireless network including, for example, a wide area network (WAN), local area network (LAN), a virtual local area network (VLAN), the Internet, and/or the like. Meanwhile, the optimizer/plan generator 130 and/or the execution engine 140 may be cloud-based systems hosted on one or more cloud-computing platforms.

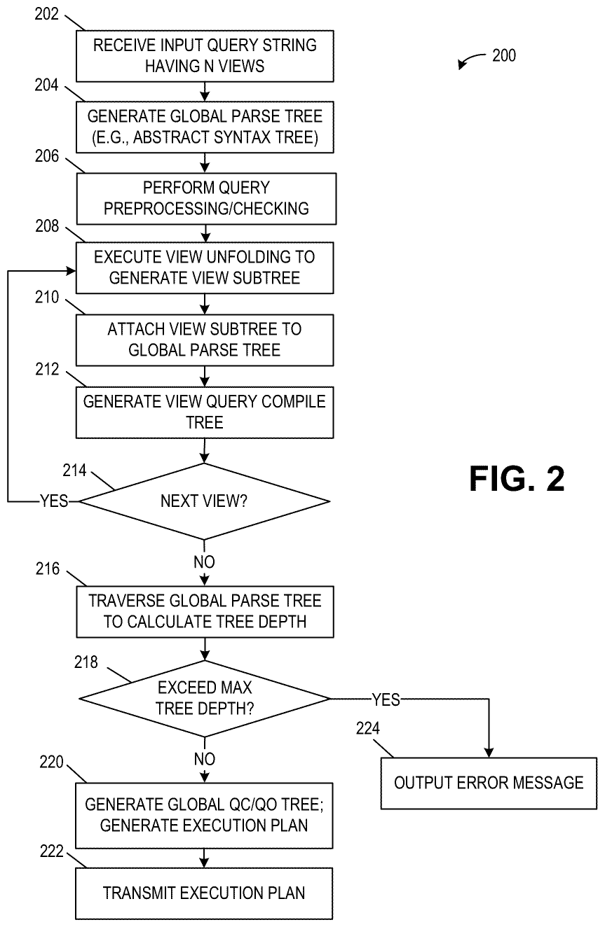

FIG. 2 depicts a flowchart 200 illustrating a process for optimizing database queries having multiple views, in accordance with some example embodiments. Referring to FIGS. 1-2, the process 200 may be performed using an multiple view query optimization computing platform 110.

Referring to FIG. 2, at step 202, multiple view query optimization computing platform 110 may receive and parse an input query string having multiple views (e.g., N views). Views in SQL databases include virtual tables that are built from SELECT query results. Views provide a mechanism to show data from one or more tables in an organized form. In SQL, a view is a virtual table based on the dynamic results returned in response to an SQL statement. When a user queries an SQL view, the database uses the view's SQL statement to recreate the data specified in the SQL view. The data displayed in an SQL view may be extracted from one or more database tables.

Views may be used in SQL databases, for example, to increase security, illustrate data more effectively, and simplify complex searches. Views may include virtual tables that are built from SELECT query results. A view may contain rows and columns from one or more tables of the same database. SQL functions such as WHERE or JOIN statements may be added to a view, and the resulting data may be presented as if it were from a single table.

In various scenarios, a query may have multiple structured query language (SQL) views on data. For example, in combining views, the SQL UNION or UNION ALL operator may be used to combine the result set of two or more SELECT statements as follows:

SELECT * FROM V1 UNION ALL SELECT * FROM V2 UNION ALL SELECT * FROM V3
UNION ALL SELECT * FROM V4 UNION ALL SELECT * FROM V5 UNION ALL SELECT
* FROM V6 UNION ALL SELECT * FROM V7 UNION ALL SELECT * FROM V8 UNION
ALL SELECT * FROM V9 UNION ALL SELECT * FROM V10.

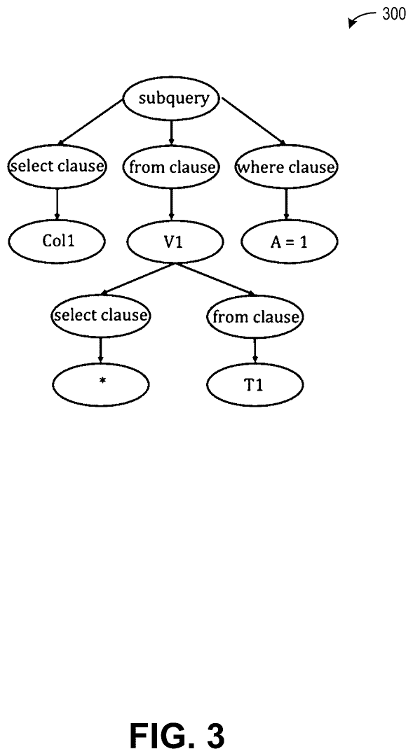

At step 204, multiple view query optimization computing platform 110 may generate a global parse tree (e.g., an abstract syntax tree (AST)). The parse tree may be generated from the query stream. For example, the parse tree may include a visual representation of the syntactic structure of source code as produced by a parser, showing the hierarchy of elements in the code and the relationships between them. FIG. 3 depicts an example query parse tree 300 in accordance with some example embodiments.

At step 206, multiple view query optimization computing platform 110 may perform preprocessing including semantic and syntactic checking of the query using the parse tree. For example, when a statement is parsed, it is translated into a form that can be understood by a compiler. The syntax and semantics of the executed statement are then checked. An error is triggered if the syntax of the statement is incorrect, which will also cause the execution of the statement to fail. A semantic check checks the catalog to verify whether the objects called by the SQL statement are present in the specified schema. When these processes have completed, a query optimizer object (e.g., QO tree) is created. The query optimizer object, often referred to as a QO tree, is a basic object that has undergone a language translation. The task of the query optimizer is to optimize the tree so that it runs faster, while at the same time ensuring that its data integrity is upheld.

At step 208, multiple view query optimization computing platform 110 may traverse the global parse tree (e.g., AST) to find SQL views, and for each view, execute view unfolding to generate view subtrees (sub-parse tree). In executing view unfolding, query optimization computing platform 110 may replace each view with its underlying objects.

At step 210, multiple view query optimization computing platform 110 may attach view subtrees to the global parse tree. A global parse tree may have one or more view nodes (e.g., V1). These view nodes are unfolded and the view subtree is attached to the global parse tree.

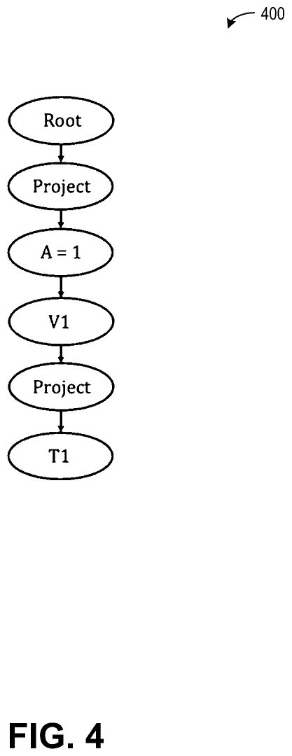

At step 212, multiple view query optimization computing platform 110 may generate a view query compile (QC) tree (e.g., a sub-query compile tree). The QC tree shows the high-level query plan structure. In the tree view, each node represents a query operator, and the link between nodes shows the connection between parent and child operators. An example QC tree 400 is illustrated in FIG. 4.

At step 214, multiple view query optimization computing platform 110 may determine whether there is another (e.g., next or subsequent) view defined by the query. If it is determined that there is another view defined by the query (e.g., at 214:YES), then, for each next view, multiple view query optimization computing platform 110 may return to step 208 to execute subsequent view unfolding and attaching of view subtrees to the global parse tree. Tree depth checking is skipped. If it is determined that there is not another view defined by the query (e.g., at 214:NO), for example, when all SQL views are unfolded, then multiple view query optimization computing platform 110 may, at step 216, traverse the global parse tree to calculate tree depth. In this way, the tree depth check is performed once regardless of the number of views defined by a query. Redundant tree depth checks may be avoided or kept to a minimum as in general it decreases performance of query execution. Among other advantages, multiple view query optimization computing platform 110 may optimize query execution involving multiple views by efficiently unfolding SQL views and avoiding redundant tree depth checks.

When the last view is unfolded, all the view subtrees will be attached to the global parse tree. This global parse tree will contain all the view information. Then, a depth check may be performed once to obtain the tree depth calculation (e.g., number of levels of the tree). This number may be compared to a maximum tree depth to determine whether the condition is exceeded or not. A maximum tree depth sets a depth of a tree or the maximum number of nodes it can branch out beneath a root node.

For each view, a sub-parse tree and a sub-QC tree may be generated. Regardless of whether the query contains one or many views, there will be only one global parse tree and one global QC tree. For each view, multiple view query optimization computing platform 110 may attach the corresponding sub-parse tree and sub-QC tree to the global parse tree and the global QC tree, respectively.

At step 218, multiple view query optimization computing platform 110 may determine whether tree depth exceeds a predetermined value (e.g., a maximum tree depth). A maximum tree depth limits the depth (e.g., number of levels) of each tree, for example to prevent overfitting of training data. If the maximum tree depth has not been exceeded (e.g., at 218:NO), then the process proceeds to step 220 to generate a global query compile/query optimized (QC/QO) tree, and generate an execution plan. At step 222, multiple view query optimization computing platform 110 may deliver the execution plan to an execution engine. For example, once the optimization phase has completed, an execution plan may be created through a code generation process and sent to different execution engines (e.g., a row engine and a column engine). The execution plan shows detailed information on the query execution and the associated operations.

If the maximum tree depth has been exceeded (e.g., at 218: YES), then multiple view query optimization computing platform 110 may output an error or warning message at step 224 (e.g., a numerical error code indicating that the SQL parse tree depth exceeds its maximum).

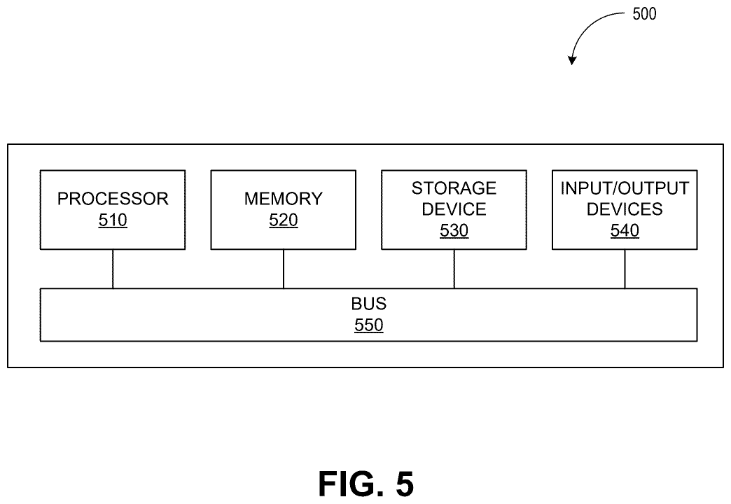

FIG. 5 depicts a block diagram illustrating a computing system 500 consistent with implementations of the current subject matter. Referring to FIGS. 1-5, the computing system 500 can be used to implement the multiple view query optimization computing platform 110 and/or any components therein.

As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The processor 510 is capable of processing instructions for execution within the computing system 500. Such executed instructions can implement one or more components of, for example, the multiple view query optimization computing platform 110. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a solid-state device, a floppy disk device, a hard disk device, an optical disk device, a tape device, and/or any other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising:
at least one processor; and
at least one memory storing instructions, which when executed by the at least one processor, result in operations comprising:
   receiving a query, wherein the query defines multiple views;
   generating a parse tree based on the query;
   preprocessing the query using the parse tree;
   traversing the parse tree to identify the multiple views;
   executing, for a current view of the multiple views, view unfolding to generate a view subtree;
   attaching the view subtree to the parse tree;
   generating a view query compile tree;
   determining whether there is another view defined by the query;
   in response to determining that there is not another view defined by the query:
      traversing the parse tree to calculate tree depth of the parse tree;
      determining whether the tree depth exceeds a predetermined value; and
      in response to determining that the tree depth does not exceed the predetermined value, generating an execution plan; and
   in response to determining that there is another view defined by the query, skipping calculation of the tree depth of the parse tree.

Example 2: The system of Example 1, further comprising, in response to determining that there is another view defined by the query: executing subsequent view unfolding to generate a subsequent view subtree; and attaching the subsequent view subtree to the parse tree.

Example 3: The system of any of Examples 1-2, wherein the preprocessing comprises: semantic and syntactic checking of the query using the parse tree.

Example 4: The system of any of Examples 1-3, wherein determining whether there is another view defined by the query comprises determining whether the current view is a last view defined by the query.

Example 5: The system of any of Examples 1-4, further comprising: in response to determining that there is another view defined by the query, performing view unfolding for a next view and attaching a view subtree for the next view to the parse tree.

Example 6: The system of any of Examples 1-5, wherein the predetermined value is a maximum tree depth.

Example 7: The system of any of Examples 1-6, further comprising: in response to determining that the tree depth exceeds a predetermined value, outputting an error message.

Example 8: The system of any of Examples 1-7, further comprising: in response to determining that the tree depth does not exceed the predetermined value, generating a query optimized tree.

Example 9: The system of any of Examples 1-8, further comprising: transmitting the execution plan to an execution engine

Example 10: A computer-implemented method comprising: receiving a query, wherein the query defines multiple views;
generating a parse tree based on the query;
preprocessing the query using the parse tree;
traversing the parse tree to identify the multiple views;
executing, for a current view of the multiple views, view unfolding to generate a view subtree;
attaching the view subtree to the parse tree;
generating a view query compile tree;
determining whether there is another view defined by the query;
in response to determining that there is not another view defined by the query:
   traversing the parse tree to calculate tree depth of the parse tree;
   determining whether the tree depth exceeds a predetermined value; and
   in response to determining that the tree depth does not exceed the predetermined value, generating an execution plan; and
in response to determining that there is another view defined by the query, skipping calculation of the tree depth of the parse tree.

Example 11: The computer-implemented method of Example 10, further comprising, in response to determining that there is another view defined by the query: executing subsequent view unfolding to generate a subsequent view subtree; and attaching the subsequent view subtree to the parse tree.

Example 12: The computer-implemented method of any of Examples 10-11, wherein the preprocessing comprises: semantic and syntactic checking of the query using the parse tree.

Example 13: The computer-implemented method of any of Examples 10-12, wherein determining whether there is another view defined by the query comprises determining whether the current view is a last view defined by the query.

Example 14: The computer-implemented method of any of Examples 10-13, further comprising: in response to determining that there is another view defined by the query, performing view unfolding for a next view and attaching a view subtree for the next view to the parse tree.

Example 15: The computer-implemented method of any of Examples 10-14, wherein the predetermined value is a maximum tree depth.

Example 16: The computer-implemented method of any of Examples 10-15, further comprising: in response to determining that the tree depth exceeds a predetermined value, outputting an error message.

Example 17: The computer-implemented method of any of Examples 10-16, further comprising: in response to determining that the tree depth does not exceed the predetermined value, generating a query optimized tree.

Example 18: The computer-implemented method of any of Examples 10-17, further comprising: transmitting the execution plan to an execution engine.

Example 19: A non-transitory computer readable medium storing instructions, which when executed by at least one processor, result in operations comprising: receiving a query, wherein the query defines multiple views;
generating a parse tree based on the query;
preprocessing the query using the parse tree;
traversing the parse tree to identify the multiple views;
executing, for a current view of the multiple views, view unfolding to generate a view subtree;
attaching the view subtree to the parse tree;
generating a view query compile tree;
determining whether there is another view defined by the query;
in response to determining that there is not another view defined by the query:
   traversing the parse tree to calculate tree depth of the parse tree;
   determining whether the tree depth exceeds a predetermined value; and
   in response to determining that the tree depth does not exceed the predetermined value, generating an execution plan; and
in response to determining that there is another view defined by the query, skipping calculation of the tree depth of the parse tree.

Example 20: The non-transitory computer readable medium of Example 19, wherein the instructions, when executed by the at least one processor, further result in operations comprising, in response to determining that there is another view defined by the query: executing subsequent view unfolding to generate a subsequent view subtree; and attaching the subsequent view subtree to the parse tree.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

1. A system, comprising:
at least one processor; and
at least one memory storing instructions, which when executed by the at least one processor, result in operations comprising:
receiving a query, wherein the query defines multiple views;
generating a parse tree based on the query;
preprocessing the query using the parse tree;
traversing the parse tree to identify the multiple views;
executing, for a current view of the multiple views, view unfolding to generate a view subtree;
attaching the view subtree to the parse tree;
generating a view query compile tree;
determining whether there is another view defined by the query;
in response to determining that there is not another view defined by the query:
traversing the parse tree to calculate a tree depth of the parse tree;
determining whether the tree depth exceeds a predetermined value that corresponds to a predetermined maximum tree depth; and
in response to determining that the tree depth does not exceed the predetermined value, generating an execution plan; and
in response to determining that there is another view defined by the query, skipping calculation of the tree depth of the parse tree such that the calculation of the tree depth is performed only when there is not another view defined by the query.

2. The system of claim 1, further comprising, in response to determining that there is another view defined by the query:
executing subsequent view unfolding to generate a subsequent view subtree; and
attaching the subsequent view subtree to the parse tree.

3. The system of claim 1, wherein the preprocessing comprises: semantic and syntactic checking of the query using the parse tree.

4. The system of claim 1, wherein determining whether there is another view defined by the query comprises determining whether the current view is a last view defined by the query.

5. The system of claim 1, further comprising: in response to determining that there is another view defined by the query, performing view unfolding for a next view and attaching a view subtree for the next view to the parse tree.

6. (canceled)

7. The system of claim 1, further comprising: in response to determining that the tree depth exceeds a predetermined value, outputting an error message.

8. The system of claim 1, further comprising: in response to determining that the tree depth does not exceed the predetermined value, generating a query optimized tree.

9. The system of claim 1, further comprising: transmitting the execution plan to an execution engine.

10. A computer-implemented method comprising:
receiving a query, wherein the query defines multiple views;
generating a parse tree based on the query;
preprocessing the query using the parse tree;
traversing the parse tree to identify the multiple views;
executing, for a current view of the multiple views, view unfolding to generate a view subtree;
attaching the view subtree to the parse tree;
generating a view query compile tree;
determining whether there is another view defined by the query;
in response to determining that there is not another view defined by the query:
traversing the parse tree to calculate a tree depth of the parse tree;
determining whether the tree depth exceeds a predetermined value that corresponds to a predetermined maximum tree depth; and
in response to determining that the tree depth does not exceed the predetermined value, generating an execution plan; and
in response to determining that there is another view defined by the query, skipping calculation of the tree depth of the parse tree such that the calculation of the tree depth is performed only when there is not another view defined by the query.

11. The computer-implemented method of claim 10, further comprising, in response to determining that there is another view defined by the query:
executing subsequent view unfolding to generate a subsequent view subtree; and attaching the subsequent view subtree to the parse tree.

12. The computer-implemented method of claim 10, wherein the preprocessing comprises: semantic and syntactic checking of the query using the parse tree.

13. The computer-implemented method of claim 10, wherein determining whether there is another view defined by the query comprises determining whether the current view is a last view defined by the query.

14. The computer-implemented method of claim 10, further comprising: in response to determining that there is another view defined by the query, performing view unfolding for a next view and attaching a view subtree for the next view to the parse tree.

15. (canceled)

16. The computer-implemented method of claim 10, further comprising: in response to determining that the tree depth exceeds a predetermined value, outputting an error message.

17. The computer-implemented method of claim 10, further comprising: in response to determining that the tree depth does not exceed the predetermined value, generating a query optimized tree.

18. The computer-implemented method of claim 10, further comprising:
transmitting the execution plan to an execution engine.

19. A non-transitory computer readable medium storing instructions, which when executed by at least one processor, result in operations comprising:
receiving a query, wherein the query defines multiple views;
generating a parse tree based on the query;
preprocessing the query using the parse tree;
traversing the parse tree to identify the multiple views;
executing, for a current view of the multiple views, view unfolding to generate a view subtree;
attaching the view subtree to the parse tree;
generating a view query compile tree;
determining whether there is another view defined by the query;
in response to determining that there is not another view defined by the query:
traversing the parse tree to calculate a tree depth of the parse tree;
determining whether the tree depth exceeds a predetermined value that corresponds to a predetermined maximum tree depth; and
in response to determining that the tree depth does not exceed the predetermined value, generating an execution plan; and
in response to determining that there is another view defined by the query, skipping calculation of the tree depth of the parse tree such that the calculation of the tree depth is performed only when there is not another view defined by the query.

20. The non-transitory computer readable medium of claim 19, wherein the instructions, when executed by the at least one processor, further result in operations comprising, in response to determining that there is another view defined by the query:
executing subsequent view unfolding to generate a subsequent view subtree; and attaching the subsequent view subtree to the parse tree.
